(19) United States
(12) Patent Application Publication
(10) Pub. No.: US 2015/0095792 A1
(43) Pub. Date: Apr. 2, 2015

(54) SYSTEM AND METHOD FOR INTEGRATING A MIXED REALITY SYSTEM

(71) Applicants: Canon Information and Imaging Solutions, Inc., Melville, NY (US); Canon U.S.A., Inc., Melville, NY (US)

(72) Inventor: Hiroshi Hashimoto, Glen Cove, NY (US)

(21) Appl. No.: 14/491,293

(22) Filed: Sep. 19, 2014

Related U.S. Application Data
(60) Provisional application No. 61/885,396, filed on Oct. 1, 2013.

(51) Int. Cl. G06T 19/00; G06F 3/0481; G06F 3/0484; H04L 29/06

(52) U.S. Cl. CPC G06T 19/006; H04L 67/42; G06F 3/0481; G06F 3/04842
USPC 715/744; 709/203

(57) ABSTRACT

Methods, systems, and computer-readable media are provided. Some embodiments include receiving, at a first server, a command that includes a first instruction for execution by the first server and a second instruction for execution by a second server, the first instruction comprising an instruction to update setting information associated with a client, the setting information including information representing a first value for a setting associated with the client, the second instruction comprising an instruction to update an appearance of a virtual object. The setting information is updated, the updating including storing information representing a second value for the setting. An output request is received at the first server. In response to the output request, output data is generated using current setting information associated with the client, the current setting information including the information representing the second value for the setting. The output data is output to an output device.

### CROSS-REFERENCE TO RELATED APPLICATIONS

This application claims the benefit of U.S. Provisional Application No. 61/885,396, filed Oct. 1, 2013, which is hereby incorporated by reference herein in its entirety.

### BACKGROUND OF THE INVENTION

1. Field of the Invention

The present invention relates generally to managing resources on a network, and more particularly to a system and method for integrating a mixed reality system.

2. Description of the Related Art

Computing systems are commonly used in a network environment to provide access to resources on the network. For example, a user on a client computing system may access an application on a server computing system in order to obtain information or utilize a feature of the application. The application executing on the server computing system may provide functionality enabling the user to perform one or more tasks.

Also known are mixed reality systems which provide virtual imagery to be mixed with a real world physical environment or space. For example, a camera may capture real-world images and video from the camera may be mixed electronically with computer-generated images and presented on a display, such as a head-mounted display.

### BRIEF SUMMARY OF THE INVENTION

Methods, systems, and computer-readable media for integrating a mixed reality system are disclosed.

Some embodiments of the invention include receiving, at a first server, a command that includes a first instruction for execution by the first server and a second instruction for execution by a second server, the first instruction comprising an instruction to update setting information associated with a client, the setting information including information representing a first value for a setting associated with the client, the second instruction comprising an instruction to update an appearance of a virtual object. The setting information is updated in accordance with the first instruction, wherein the updating the setting information includes storing information representing a second value for the setting, the second value different from the first value. An output request is received at the first server. In response to the output request, output data is generated using current setting information associated with the client, the current setting information including the information representing the second value for the setting. The output data is output to an output device.

Some embodiments of the invention include receiving, at a first server, an identifier and a request to obtain setting information associated with the identifier and send the setting information to a second server; using the identifier to obtain the setting information; and sending, from the first server to the second server, the setting information and a command to apply the setting information to an image generated by the second server such that an appearance of a virtual object is updated according to the setting information.

Some embodiments of the invention include receiving, at a computing system from a client, user input information, the user input information based on one or more user inputs received at the client. A command is generated based on the user input information, the command including a first instruction for execution by a first server and a second instruction for execution by a second server, the first instruction comprising an instruction to update setting information associated with the client, the second instruction comprising an instruction to update an appearance of a virtual object. The command is sent from the computing system to the first server and to the second server.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates an example network environment.

FIGS. 2A and 2B illustrate an example flow of operations within the example network environment of FIG. 1.

FIG. 3 illustrates an example graphical user interface (GUI) on a display of a client computing device.

FIG. 4 illustrates an example sequence of commands.

FIG. 5 illustrates an example form.

FIG. 6 illustrates an example flow of operations within the example network environment of FIG. 1.

FIG. 7 illustrates an example computing system.

### DETAILED DESCRIPTION OF THE INVENTION

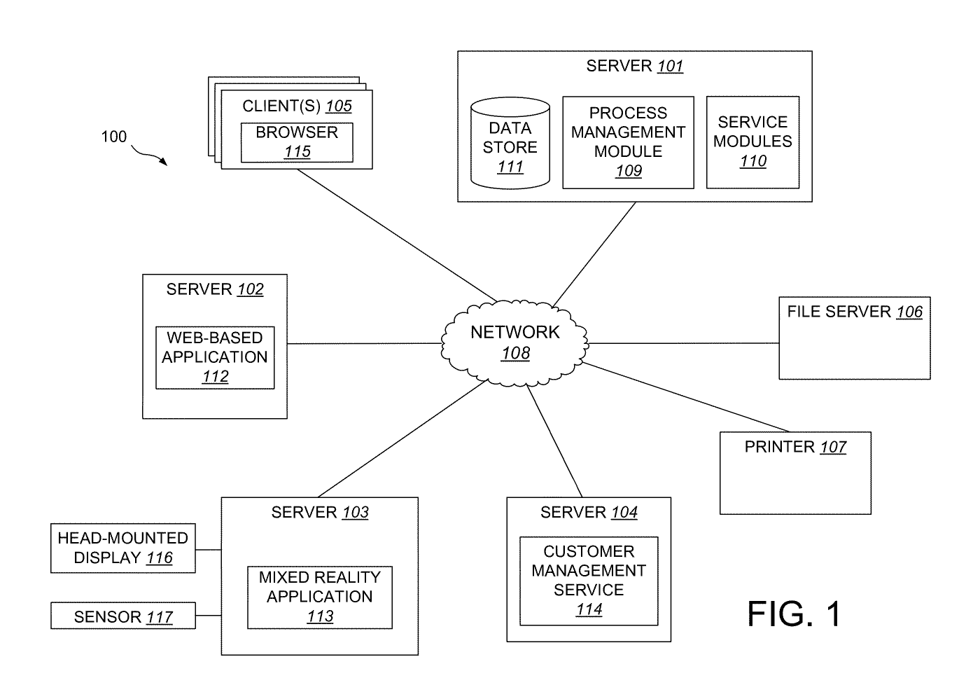

Embodiments of the present invention are described with reference to the drawings. FIG. 1 illustrates an example network environment 100. A server 101, a server 102 (also referred to herein as “web application server 102”), a server 103 (also referred to herein as “mixed reality server 103”), a server 104, one or more client(s) 105 each having a browser 115, a file server 106, and a printer 107 are connected to a network 108.

The server 101 includes the process management module 109, the service modules 110, and the data store 111. The service modules 110 provide functionality to perform various operations. The process management module 109 manages the execution of processes by invoking one or more of the service modules 110 to perform operations during execution of a process. In some embodiments, one or more of the service modules 110 are implemented as web services. The process management module 109 may maintain and access information stored in the data store 111.

The process management module 109 may include hardware, software, or both for providing the functionality of the process management module 109. The service modules 110 may include hardware, software, or both for providing the functionality of the service modules 110. In some embodiments, the process management module 109 and/or one or more of the service modules 110 executing on the server 101 perform one or more steps of one or more methods described or illustrated herein or provide functionality described or illustrated herein.

In some embodiments, the process management module 109 includes instructions and data for invoking respective services of one or more of the service modules 110. For example, the process management module 109 may be configured to send, to one of the service modules 110, a request for the service module to perform an operation specified in the request. In some embodiments, the request may include additional information, such as a portType element or other information associated with the particular service module. In some embodiments, the process management module 109 uses Simple Object Access Protocol (SOAP) to interact with the service modules 110.

In some embodiments, each of the service modules 110 includes instructions and data for performing one or more operations. In some embodiments, one or more of the service modules 110 include an interface described in Web Services Description Language (WSDL). One or more of the service modules 110 may use SOAP to receive and send messages. One or more of the service modules 110 may use Server Message Block (SMB) and/or File Transfer Protocol (FTP) to receive and send messages. In some embodiments, one or more of the service modules 110 receive, from the process management module 109, a request to perform an operation specified in the request. Instructions for performing the requested operation are then executed in response to the request.

In some embodiments, one or more of the service modules 110 provide image processing functionality. For example, one or more of the service modules 110 may support one or more of the following operations: merging multiple files into a single file; splitting a file into multiple files; inserting a page in a file; extracting a page from a file; converting a format of a file to a different format; applying optical character recognition (OCR) processing on a file; and generating a file using one or more of a format file, a template file, an image file, and a graph data file.

In some embodiments, one or more of the service modules 110 provide functionality for interacting with an input/output device. For example, one or more of the service modules 110 may support one or more of the following operations: printing of a file; faxing of a file; and initiating scanning of a document at the input/output device.

In some embodiments, one or more of the service modules 110 provide functionality for accessing one or more resources of one or more external server computing systems. For example, one or more of the service modules 110 may support one or more of the following operations: uploading a file; downloading a file; managing files by copying, moving, or deleting files; managing folders by creating, deleting, moving, or copying folders; adding an entry to a data store; deleting an entry from a data store; modifying an entry in a data store; searching for an entry in a data store; retrieving an entry from a data store; and managing data, which may be associated with a user account, of an application on the external server computing system.

The server 101 may access one or more resources on the network 108. The server 101 is configured to interact with one or more of the following: the web-based application 112 on the server 102, the mixed reality application 113 on the server 103, the customer management service 114 on the server 104, one or more of the client(s) 105, the file server 106, and the printer 107. For example, the server 101 includes programs and related data for receiving and processing commands from the web-based application 112 on the server 102.

The server 101 includes hardware, software, or both for providing the functionality of the server 101. The server 101 may comprise one or more server(s). For example, the server 101 may include one or more application(s) servers, web servers, file servers, database servers, name servers, mail servers, fax servers, or print servers. In some embodiments, the server 101 is unitary. In some embodiments, the server 101 is distributed. The server 101 may span multiple locations. The server 101 may span multiple machines.

The server 102 includes hardware, software, or both for providing the functionality of the server 102. The server 102 may include one or more servers. For example, the server 102 may include one or more application(s) servers, web servers, file servers, or database servers. In some embodiments, the server 102 is unitary. In some embodiments, the server 102 is distributed. The server 102 may span multiple locations. The server 102 may span multiple machines.

The server 102 provides access to the web-based application 112. The web-based application 112 includes programs and related data. The web-based application 112 may receive hypertext transfer protocol (HTTP) requests and provide HTTP responses. For example, the web-based application 112 may serve content in the form of a web page in response to a request from a web browser. The web page may be static or dynamic and may comprise Hyper Text Markup Language (HTML) files, or other suitable files, executable code, such as JAVASCRIPT, form elements, images, or other content. One or more elements of the web page content may be stored at the server 102. In some embodiments, the web-based application 112 uses SOAP to receive and send messages.

The server 102 may interact with one or more resources on the network 108. For example, the server 102 includes programs and related data for generating and sending commands to the server 101 and the server 103.

The server 103 includes hardware, software, or both for providing the functionality of the server 103. The server 103 may include one or more servers. For example, the server 103 may include one or more application(s) servers, or other servers. In some embodiments, the server 103 is unitary. In some embodiments, the server 103 is distributed. The server 103 may span multiple locations. The server 103 may span multiple machines.

The server 103 may interact with one or more resources on the network 108. For example, the server 103 includes programs and related data for receiving and processing commands from the web-based application 112 on the server 102.

The server 103 provides access to the mixed reality application 113. Moreover, the server 103 is coupled to the head-mounted display 116 and the sensor 117. The sensor 117 may be a camera or other suitable device. The sensor 117 captures images and provides data to the server 103, which uses the mixed reality application 113 to mix video from the sensor 117 with computer-generated images. Then the mixed reality image is displayed at the head-mounted display 116.

The server 104 includes hardware, software, or both for providing the functionality of the server 104. The server 104 may include one or more servers. For example, the server 104 may include one or more application(s) servers, web servers, file servers, or database servers. In some embodiments, the server 104 is unitary. In some embodiments, the server 104 is distributed. The server 104 may span multiple locations. The server 104 may span multiple machines.

The server 104 provides access to the customer management service 114. The customer management service 114 includes programs and related data. The customer management service 114 may include one or more programs for controlling access to the customer management service 114 or for controlling access to one or more resources of the customer management service 114. The customer management service 114 may serve content in the form of a web page in response to a request from a web browser. In some embodiments, the customer management service 114 uses SOAP to receive and send messages.

In some embodiments, the customer management service 114 is enterprise software. The customer management service 114 may provide features for managing business information and enabling content to be shared across an organization. For example, the customer management service 114 may include functionality for receiving, storing, organizing, and providing access to information, files, or other content for members of an organization or group.

The client(s) 105 includes hardware, software, or both for providing the functionality of the client(s) 105. The browser 115 may execute on the client(s) 105. The browser 115 may be a web browser and may be used to access a resource, such as a web page. The browser 115 may enable a user to display and interact with text, images, form elements, or other information typically located on a web page served by a web server on the World Wide Web or a local area network. The browser 115 may support various types of downloadable, executable, software modules, such as applets or plug-ins. For example, the browser 115 may incorporate a virtual machine configured to execute a program, such as a JAVA applet, embedded in a web page accessed by the browser 115. The client(s) 105 may have various add-ons, plug-ins, or other extensions for use in or with the browser 115.

The client(s) 105 include hardware, software, or both enabling the output of signals and the receiving of input signals so as to facilitate interaction between a user and the client(s) 105. The client(s) 105 may include a hard key panel and/or a touch sensitive display. A user may provide user inputs via the hard key panel and/or the touch sensitive display to control the client(s) 105. For example, the user may press one or more hard buttons to issue one or more commands. Further by way of example, a user may provide a touch input to an interface element displayed on the display to issue a command and/or to make a selection. Moreover, the client(s) 105 may output information to the user and issue requests by outputting images on a display.

The network 108 couples one or more servers and one or more clients to each other. The network 108 may be any suitable network. For example, one or more portions of the network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 108 may include one or more networks.

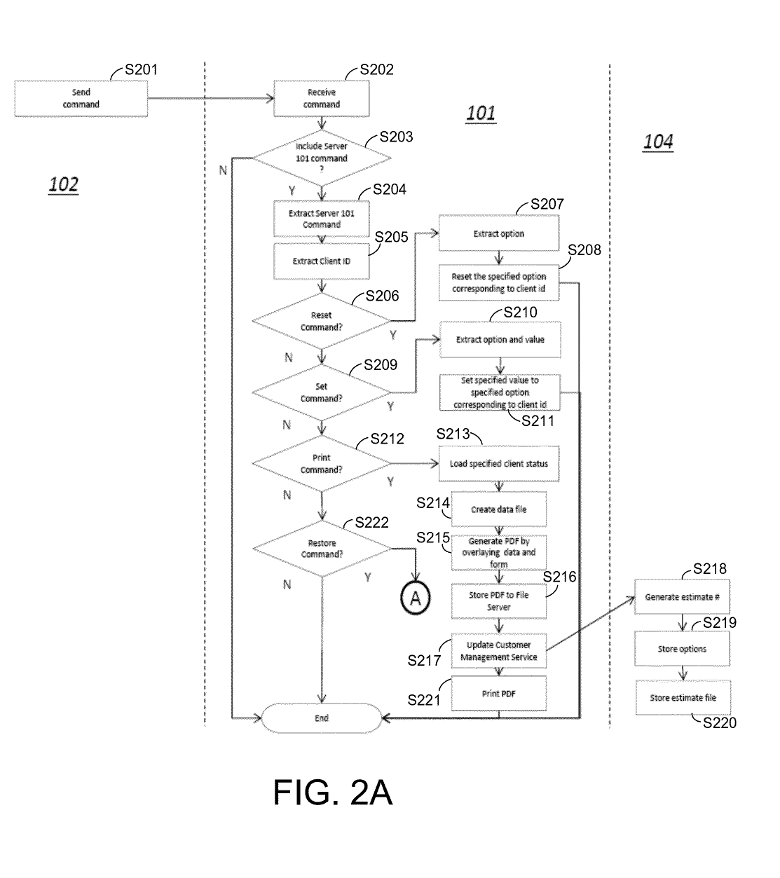

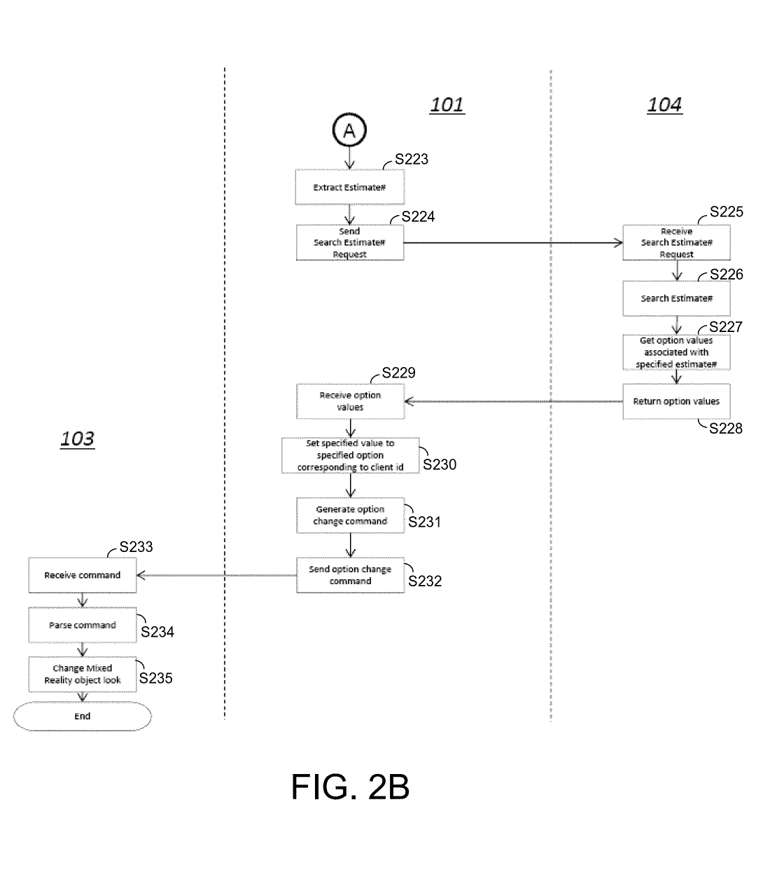

FIGS. 2A and 2B are described with reference to the example network environment 100 of FIG. 1. FIGS. 2A and 2B illustrate an example flow of operations within the example network environment 100 of FIG. 1.

In step S201, the web application server 102 sends a command to the server 101. In some embodiments, the command includes instructions for execution by the server 101 and instructions for execution by a server different from the server 101. For example, the command may include instructions for execution by the mixed reality server 103 and instructions for execution by the server 101.

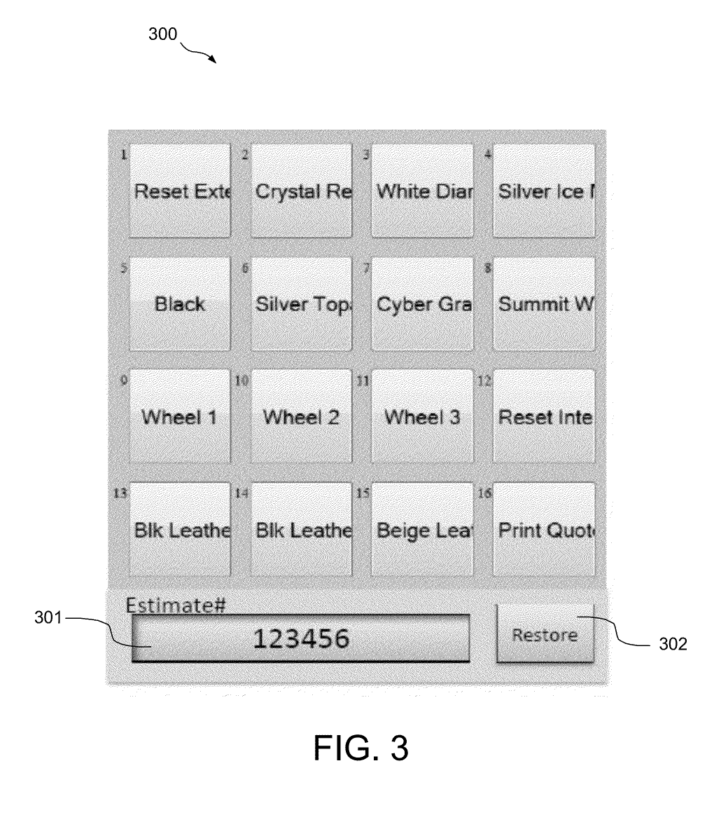

In some embodiments, the command is based on a user input to an interface element displayed on a touch sensitive display. For example, the example GUI 300 of FIG. 3 may be presented on the display at the client 105 and a user may select an interface element by touching a portion of the display where the interface element is presented.

FIG. 3 illustrates an example GUI 300 having various interface elements for providing instructions to a mixed reality system. The example GUI 300 is rendered when the browser 115 accesses the web-based application 112 and displays the GUI file or web page. The display of the client 105 comprises a touch sensitive element operable to receive user inputs or commands based on the touching of interface elements presented in the GUI 300 on the display. The interface elements may be graphical objects displayed on the display.

The example GUI 300 includes a form element 301, a Restore button 302, and sixteen buttons for providing instructions to a mixed reality system. The form element 301 is for entering an Estimate Number to be submitted to the server 102. The Restore button 302 is an interface element providing functionality to submit to the server 102 an estimate number entered in the form element 301.

The sixteen buttons for interacting with the mixed reality system provide functionality for modifying features of a virtual object. The following buttons are included: one button to reset exterior settings, which include settings for color of car and type of wheel, to respective default settings; seven buttons to select a color for the exterior; three buttons to select a type of wheel; one button to reset the interior to a default setting; three buttons to select a package for the interior; and one button to print a quote.

In some embodiments, the command sent in step S201 is issued in response to a selection of an interface element such as provided in the example GUI 300. However, any suitable GUI may be utilized, including a GUI having features and/or interface elements different from those provided in the example GUI 300. Moreover, the command sent in step S201 may be different from the commands which may be issued by selecting an interface element in the example GUI 300. In some embodiments, a user may provide multiple selections which may be simultaneously submitted to the web-based application 112.

In step S202, the server 101 receives the command sent in step S201. The server 101 then initiates reading the command for execution. In some embodiments, the server 101 utilizes one or more programs and related data to parse and execute commands from the web-based application 112.

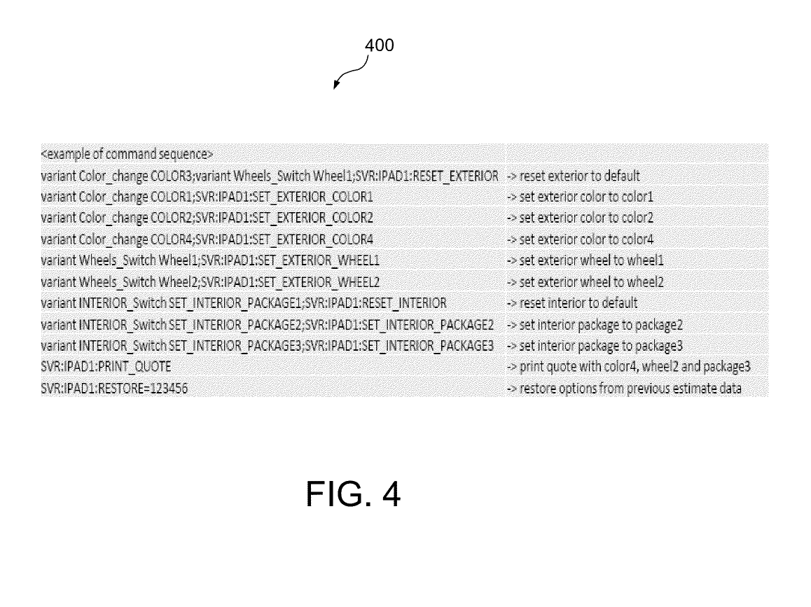

Some steps of FIG. 2 are described with reference to FIG. 4. FIG. 4 illustrates an example sequence of commands 400.

In step S203, the server 101 determines whether the command received in step S202 includes instructions for execution by the server 101. For example, the server 101 may execute operations to read the contents of the command to determine whether the command includes information that identifies the server 101. Any suitable information may be used as an identifier, such as the name of the server 101, information associated with the server 101, or other information. If the information is included in the command, the server 101 may determine the command received in step S202 includes instructions for execution by the server 101. On the other hand, if the information is not included in the command, the server 101 may determine the command received in step S202 does not include instructions for execution by the server 101.

By way of example, in the example sequence of commands 400, the character string “SVR” is information that identifies the server 101. Accordingly, the server 101 determines, for each command in the example sequence of commands 400, that the command includes instructions for execution by the server 101 based on the presence of the character string “SVR” in the command.

If the server 101 determines the command does not include instructions for execution by the server 101 (no in step S203), then the process ends. On the other hand, if the server 101 determines the command includes instructions for execution by the server 101 (yes in step S203), the process advances to step S204.

In step S204, the server 101 extracts the command information that is for execution by the server 101. In some embodiments, at least a portion of the command information which is not extracted by the server 101 in step S204 is command information for execution by the mixed reality server 103. By way of example, in the example sequence of commands 400, information following the character string “SVR” is for execution by the server 101. Information that precedes the character string “SVR” pertains to the mixed reality server 103.

In step S205, the server 101 extracts information that identifies the client 105 that issued the command. Based on the extracted information, the server 101 identifies the client 105 and executes operations according to the identification of the client. By way of example, in the example sequence of commands 400, the character string “IPAD1” is information that identifies the client.

In step S206, the server 101 determines whether the command includes an instruction to reset one or more settings to default setting(s). If the command includes an instruction to reset one or more settings to default setting(s) (yes in step S206), the process advances to step S207.

In step S207, the server 101 extracts, from the command, the information that indicates which settings to reset. By way of example, in the example sequence of commands 400, the first command listed is a command to reset the settings associated with the exterior of a virtual car. The example sequence of commands 400 corresponds to commands issued in response to user inputs via the example GUI 300. The command to reset the settings associated with the exterior of the virtual car was issued by selecting, in the example GUI 300, the interface element to reset exterior settings. The example GUI 300 includes two interface elements for resetting. The interface element to reset the exterior will cause current exterior settings to be reset to default value(s). The interface element to reset the interior will cause current interior settings to be reset to default value(s). Referring to the example sequence of commands 400, in response to determining the first command is a reset command, the server 101 then identifies that exterior settings are to be reset based on the character string “EXTERIOR” included in the command.

In step S208, the server 101 resets the settings in accordance with the command information extracted in step S207 and in accordance with the client information extracted in step S205. By way of example, in the first command of the example sequence of commands 400, settings that are associated with the client identifier “IPAD1” and which pertain to the exterior of the virtual car are reset. Accordingly, for settings associated with the client, the color of the exterior of the car is reset to a predetermined default value. Additionally, the type of wheel on the virtual car is reset to a predetermined default value.

The settings may be stored in any suitable manner at any suitable memory or storage device. In some embodiments, the server 101 stores settings in the data store 111. In some embodiments, settings are stored for multiple clients. For example, current settings associated with each respective client may be stored in the data store 111. In some embodiments, the server 101 stores a log of commands received for each respective client.

After the command has been executed by resetting the specified setting(s) to default value(s), the process ends. Referring to step S206, if the server 101 determines the command does not include an instruction to reset one or more settings (no in step S206), the process advances to step S209.

In step S209, the server 101 determines whether the command includes an instruction to set a value for one or more settings. If the command includes an instruction to set a value for a setting (yes in step S209), the process advances to step S210.

In step S210, the server 101 extracts, from the command, information that indicates the setting(s) to be set and the value(s) for the setting(s). By way of example, in the example sequence of commands 400, the second command listed is a command to set a color corresponding to “COLOR1” as the color of the exterior of the virtual car. The command was issued by selecting, in the example GUI 300, the interface element corresponding to that color.

In step S211, the server 101 sets value(s) for the setting(s) in accordance with the command information extracted in step S210 and in accordance with the client information extracted in step S205. By way of example, in response to the second command of the example sequence of commands 400, the server 101 sets a color corresponding to “COLOR1” as the color of the exterior of the virtual car for the settings associated with the client identifier “IPAD1.”

After the command has been executed by setting the specified value(s) for the setting(s), the process ends. Referring to step S209, if the server 101 determines the command does not include an instruction to set a value for one or more settings (no in step S209), the process advances to step S212.

In step S212, the server 101 determines whether the command includes an instruction to print. If the command includes an instruction to print (yes in step S212), the process advances to step S213.

Steps S213 to S221 represent an example output process. The example output process of steps S213 to S221 may be associated with the web-based application 112. For example, the example output process of steps S213 to S221 may be a predetermined sequence of operations to be performed in response to a request, from the web-based application 112, to perform the operations. By way of example, in response to the “PRINT_QUOTE” command of the example sequence of commands 400, the server 101 may execute the predetermined set of operations.

In some embodiments, the process management module 109 manages the execution of the output process of steps S213 to S221 by invoking one or more of the service modules 110 to perform operations during execution of the process. Each of the service modules 110 invoked during the process includes instructions and data for performing the requested operation. While particular operations are described with respect to steps S213 to S221, various sequences of operations are contemplated, including a process that includes operations different from those included in steps S213 to S221. Any suitable operation(s) arranged in any suitable sequence may be implemented in response to determining that the command includes the instruction to print.

In step S213, the server 101 loads current settings associated with the client 105 identified in step S205. The current settings are a reflection of the status of the virtual car with respect to the client 105. In some embodiments, the server 101 retrieves the current settings from the data store 111. In some embodiments, in response to each command, the server 101 performs one or more operations to maintain the setting information in the data store 111. For example, in response to a command to set wheel type 1 to wheel type 2 for the client 105, the server 101 may update the setting information for the client 105 such that only current settings for the client 105 are stored in the data store 111, the current settings including wheel type 2 for the type of wheel on the virtual car. In some embodiments, the server 101 stores each command received in a log and, to determine current settings for the client 105, the server 101 identifies the current value for each setting based on the sequence of commands in the log. In some embodiments, the web-based application 112 may maintain the current settings information and/or log of commands and provide, to the server 101, the current settings for the client 105 together with the print request. The current settings may be stored and retrieved in any suitable manner.

The server 101 loads the current settings associated with the client 105 identified in the print command. By way of example, in response to the “PRINT_QUOTE” command of the example sequence of commands 400, the server 101 loads setting information for client “IPAD1,” the information representing the values color4, wheel2, and package3 for the settings exterior color, wheel type and interior package, respectively.

In step S214, the server 101 creates a data file using the current settings loaded in step S213. In some embodiments, the server 101 creates the data file using the current setting information and additional information relating to the print command. For example, in the example sequence of commands 400, the print command is a command to print an estimate for the purchase of a car. Accordingly, the server 101 may retrieve information such as make and model of the car, price information, car dealer information, or other information for presentation in conjunction with the setting information about color, wheel type and interior. By way of example, the additional information may be stored in the data store 111, received from the web application server 102, or obtained from remote storage, such as the file server 106.

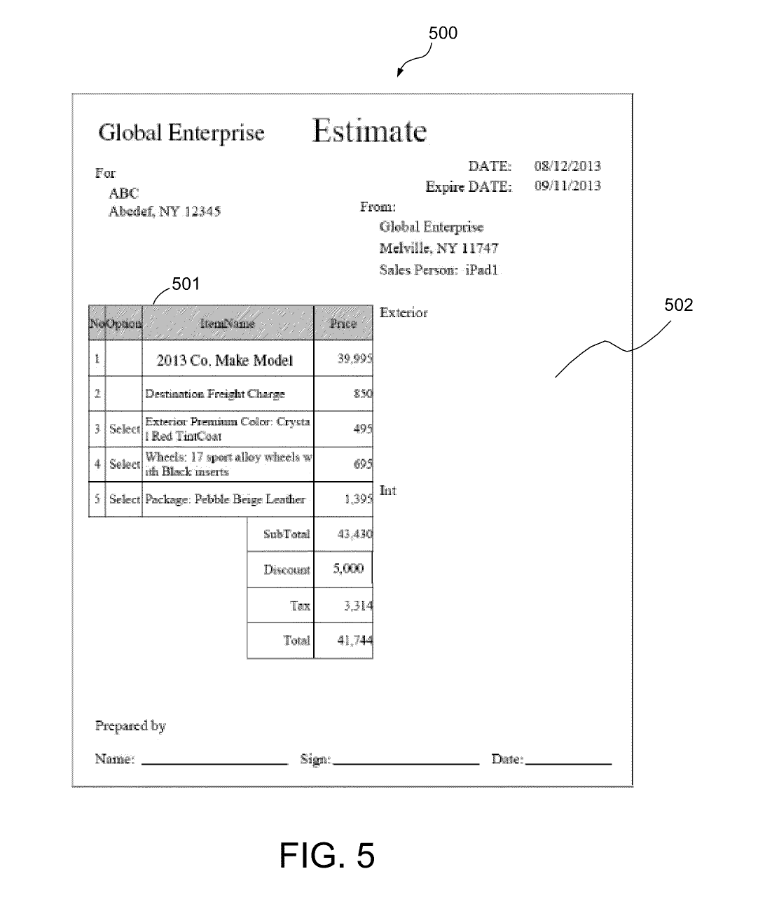

In step S215, the server 101 generates an electronic document by combining a layout template and the data from the data file created in step S214. For example, data from a DAT or CSV format file may be merged with a template associated with the web-based application 112. The example form 500 of FIG. 5 includes text from the data file combined with a predefined layout template. Template elements include the grid lines of the table 501 and the name, signature, and date information shown at the bottom of the example form 500. Current setting information is included as items 3, 4 and 5 in the table 501, and price adjustments based on the selections are indicated. Additional information from the data file shown in the example form 500 includes car dealership information, information about the car, and price information. Prior to printing the example form 500, image files may also be combined with the data from the data file and the template. For example, images of the exterior and interior of the car according to the setting information of the client 105 may be included in area 502 of the example form 500. The combined file may be a Portable Document Format (PDF) file.

In step S216, the server 101 performs operations to store the electronic document generated in step S215. For example, the server 101 may store the electronic document in the file server 106. In the file server 106, the server 101 may generate a folder for each respective client 105 for which data is stored.

In step S217, the server 101 updates the customer management service 114. To interact with the customer management service 114, the server 101 may execute programs and utilize data for use in accessing one or more services of the customer management service 114. The server 101 may use SOAP to interact with the customer management service 114. In some embodiments, the server 101 sends the electronic document generated in step S215 to the customer management service 114 with a request to store the electronic document in an account of the customer management service 114 that is associated with the server 101. Additionally, the server 101 may request that information associated with the account be updated.

Steps S218 to S220 represent a process for generating and storing information that identifies the estimate generated by the output process of steps S213 to S221. The settings selected by the client 105 (for example, settings for color, wheel type, and interior of the virtual car) may be stored and associated with the information that identifies the estimate. The information that identifies the estimate may be a numeric or alphanumeric string of characters. In some embodiments, the server 101 performs the steps S218 to S220. In the current embodiment described with reference to FIG. 2A, the server 101 sends to the customer management service 104 the settings selected by the client 105 and a request to execute steps S218 to S220.

In step S218, the customer management service 104 generates the information that identifies the estimate. In some embodiments, the string of numeric or alphanumeric characters is generated using an algorithm. In some embodiments, the string of characters comprises random or pseudo-random data. In some embodiments, the string of characters includes one or more of the following components: a prefix (for example, the characters “ES” may be used to indicate the string of characters is an estimate), a date (for example, the characters “09012013” may indicate that the estimate was generated on Sep. 1, 2013), and a sequential number (for example, the characters “0001” could be appended at the end of other characters to indicate the string of characters represent the first estimate output on the date specified in the string). Any suitable method of producing a unique string of characters may be utilized.

In step S219, the customer management service 104 stores the settings selected by the client 105 in a data store of the customer management service 104. In step S220, the customer management service 104 stores the string of characters generated in step S218 with the settings stored in step S219. The customer management service 104 stores the string of characters and the settings such that the respective values are associated with each other in the data store.

In step S221, the server 101 sends the electronic document generated in step S215 to the printer 107. The printer 107 is any suitable device for printing, such as a multifunction peripheral, a copier, or a single-function printer. The printer 107 outputs the estimate and the process ends. Referring to step S212, if the server 101 determines the command does not include an instruction to print (no in step S212), the process advances to step S222.

In step S222, the server 101 determines whether the command includes an instruction to restore settings. If the command does not include an instruction to restore settings (no in step S222), the process ends. On the other hand, if the command includes an instruction to restore settings (yes in step S222), the process advances to step S223 of FIG. 2B.

In step S223, the server 101 extracts, from the command, information that identifies an estimate that was previously output. By way of example, in the example sequence of commands 400, the last command listed includes the character string “RESTORE=123456” which indicates that the command is a command to restore settings for an estimate identified by the character string “123456.” The character string “123456” is an example estimate number; however, any suitable character string representing information that identifies the particular estimate could be used. For example, the character string could be a character string that was generated in the manner described with respect to step S218. The last command in the example sequence of commands 400 corresponds to selection of the Restore button 302 in the example GUI 300 to submit an estimate number “123456” entered in the form element 301. Accordingly, the server 101 extracts “123456” from the command.

Steps S224 to S229 represent a process for obtaining the setting values associated with the information extracted in step S223. The server 101 performs operations using the information that identifies the estimate (for example, “123456”) to obtain the setting values. In some embodiments, the server 101 searches in the data store 111, file server 106, or other storage, and identifies the setting values associated with the information extracted in step S223.

In the current embodiment described with reference to FIG. 2B, in step S224, the server 101 sends to the customer management service 114 the information that identifies the estimate (for example, “123456”) and a request for the setting values associated with the information that identifies the estimate.

In step S225, the customer management service 114 receives the request and the information that identifies the estimate. In step S226, the customer management service 114 searches a data store associated with the customer management service 114 and identifies the estimate identifier (for example, “123456”). In step S227, the customer management service 114 retrieves the settings associated with the estimate identifier. For example, the settings may be settings previously selected by the client 105 and stored by the customer management service 114 on another occasion. The settings may be, for example, settings for color, wheel type, and interior of the virtual car. In step S228, the customer management service 114 sends the settings to the server 101.

In step S229, the server 101 receives the settings from the customer management service 114. In step S230, the server 101 sets values in the data store 111, or other storage, for each of the settings and in accordance with the client information extracted in step S205. By way of example, in response to the restore command of the example sequence of commands 400, the server 101 sets setting information for client “IPAD1” according to the values received in step S229.

In step S231, the server 101 generates a command for execution by the mixed reality server 103. The server 101 includes programs and related data for communicating with the mixed reality server 103. By way of example, if the values of the settings received in step S229 were color3, wheel2, and package2 for the color, wheel type, and interior of the virtual car, respectively, the server 101 may generate a command including “variant Color_change COLOR3” for the color, “variant Wheels_Switch Wheel2” for the wheel type, and “variant INTERIOR_Switch SET_INTERIOR_PACKAGE2” for the interior. In some embodiments, the server 101 may send the command to the mixed reality server 103 as a plain text message using TCP/IP. In some embodiments, the server 101 uses SOAP to interact with the mixed reality server 103.

In step S232, the server 101 sends to the mixed reality server 103 the command generated in step S231 in order to change the status of the displayed virtual car according to the settings received in step S229.

In step S233, the mixed reality server 103 receives the command sent in step S232. In step S234, the mixed reality server 103 parses the command to determine the contents. For example, the mixed reality server 103 may read the example command described with respect to step S231 and determine that the setting values to apply at the mixed reality server 103 are the following: color3, wheel2, and package2 for the color, wheel type, and interior of the virtual car, respectively.

In step S235, the mixed reality server 103 applies the setting values to the computer-generated image displayed at the head-mounted display 116. For example, the mixed reality server 103 may set values of color3, wheel2, and package2 for the color, wheel type, and interior of the virtual car, respectively. The appearance of the displayed virtual car is updated accordingly and the process ends.

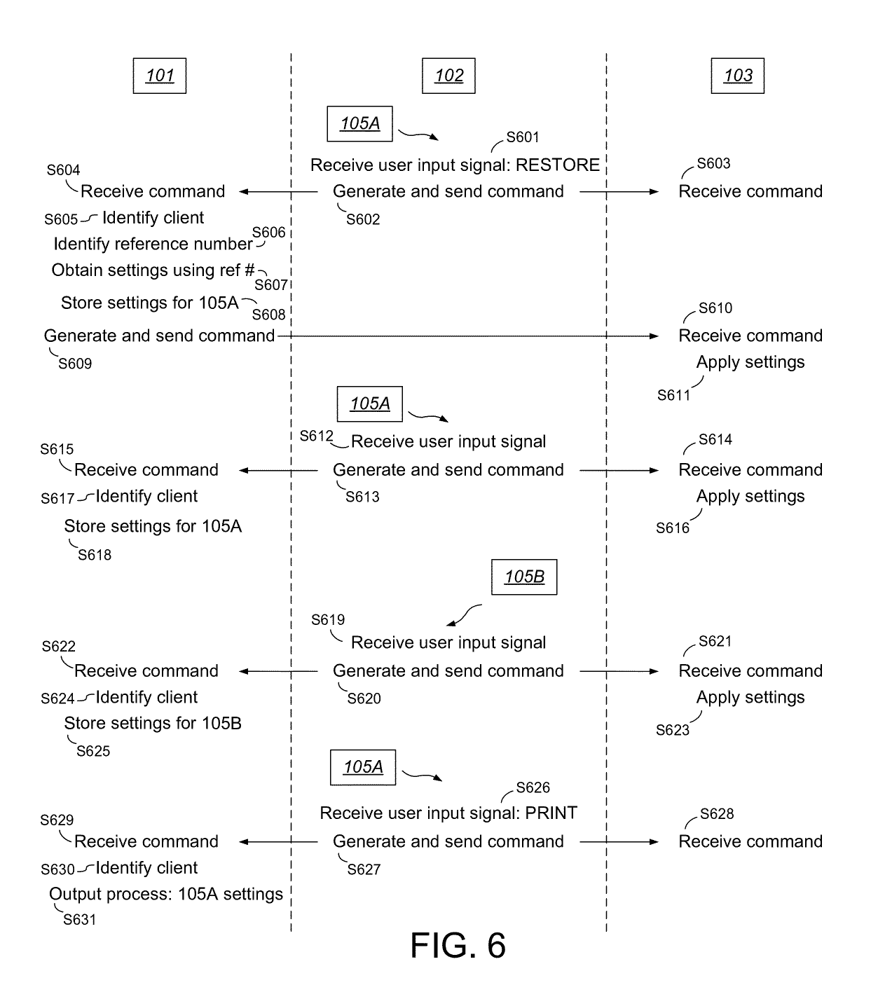

FIG. 6 illustrates an example flow of operations within the example network environment of FIG. 1.

In step S601, the web application server 102 receives a user input signal based on a user selection at a first client 105A. The user selection corresponds to a restore command such as described with reference to FIGS. 2A and 2B. In step S602, the web application server 102 generates and sends a restore command to the server 101 and the mixed reality server 103. In step S603, the mixed reality server 103 receives the restore command. However, because the restore command does not include instructions for execution by the mixed reality server 103, the mixed reality server 103 only reads the command.

In step S604, the server 101 receives the restore command. The server 101 identifies that the restore command does have instructions for execution by the server 101 and the server 101 identifies the first client 105A in step S605. In steps S606 to S609 the server 101 performs operations such as described with respect to steps S223 to S232 with reference to FIG. 2B. In steps S610 to S611, the mixed reality server 103 performs operations such as described with respect to steps S233 to S235 with reference to FIG. 2B.

In step S612, the web application server 102 receives a user input signal based on a user selection at the first client 105A. By way of example, after entering an estimate number and selecting the Restore button 302 in the example GUI 300 (step S601), the user made an additional selection in the example GUI 300 in order to set a new value to a setting (step S612). In step S613, the web application server 102 generates and sends a command to the server 101 and the mixed reality server 103 based on the selection to change the value of a setting.

In step S614 and step S615, the mixed reality server 103 and the server 101, respectively, receive the command from the web application server 102. The mixed reality server 103 reads the command and determines the command includes instructions for execution by the mixed reality server 103. Accordingly, in step S616, the mixed reality server 103 applies the settings with the updated value and the appearance of the displayed virtual car is updated accordingly.

In step S617, the server 101 identifies the first client 105A. In step S618, the server 101 performs operations such as described with respect to steps S210 and S211 with reference to FIG. 2A such that the settings stored for the first client 105A are updated.

In step S619, the web application server 102 receives a user input signal based on a user selection at a second client 105B. The user selection is a selection to reset the exterior settings for the virtual car to default settings. In step S620, the web application server 102 generates and sends a command to the server 101 and the mixed reality server 103 based on the selection to reset the exterior settings.

In step S621 and step S622, the mixed reality server 103 and the server 101, respectively, receive the command from the web application server 102. The mixed reality server 103 reads the command and determines the command includes instructions for execution by the mixed reality server 103. Accordingly, in step S623, the mixed reality server 103 applies the settings with the reset values and the appearance of the displayed virtual car is updated accordingly.

In step S624, the server 101 identifies the second client 105B. In step S625, the server 101 performs operations such as described with respect to steps S207 and S208 with reference to FIG. 2A. However, the server 101 performs the operations with respect to the second client 105B such that the settings stored for the second client 105B are updated. The settings for the first client 105A remain as set in step S618.

In step S626, the web application server 102 receives a user input signal based on a user selection at the first client 105A. The user selection corresponds to a print command. In step S627, the web application server 102 generates and sends a print command to the server 101 and the mixed reality server 103. In step S628, the mixed reality server 103 receives the print command. However, because the print command does not include instructions for execution by the mixed reality server 103, the mixed reality server 103 only reads the command.

In step S629, the server 101 receives the print command. The server 101 identifies that the print command does have instructions for execution by the server 101 and the server 101 identifies the first client 105A in step S630. In step S631, the server 101 performs an output process based on the current settings for the first client 105A. The settings for the first client 105A remain as set in step S618. The server 101 performs operations such as described with respect to steps S212 to S221 with reference to FIG. 2A. Thus, even though the current appearance of the displayed virtual car does not correspond to the current settings of the first client 105A, the estimate printed out and stored for the first client 105A will reflect the status of the virtual car based on the last selection by the first client 105A.

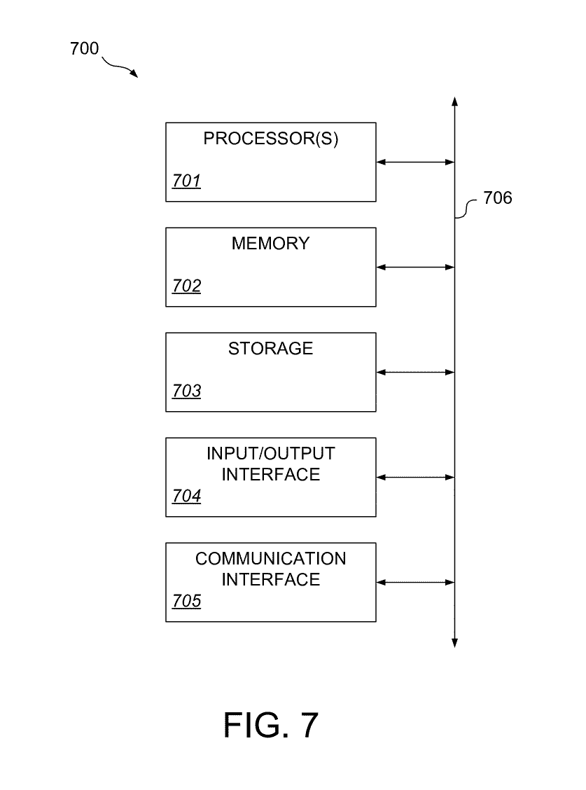

FIG. 7 illustrates an example computing system 700. According to various embodiments, all or a portion of the description of the computing system 700 is applicable to all or a portion of one or more of the server 101, the server 102, the server 103, the server 104, the one or more client(s) 105, and the file server 106.

The term computing system as used herein includes but is not limited to one or more software modules, one or more hardware modules, one or more firmware modules, or combinations thereof, that work together to perform operations on electronic data. The physical layout of the modules may vary. A computing system may include multiple computing devices coupled via a network. A computing system may include a single computing device where internal modules (such as a memory and processor) work together to perform operations on electronic data. Also, the term resource as used herein includes but is not limited to an object that can be processed at a computing system. A resource can be a portion of executable instructions or data.

In some embodiments, the computing system 700 performs one or more steps of one or more methods described or illustrated herein. In some embodiments, the computing system 700 provides functionality described or illustrated herein. In some embodiments, software running on the computing system 700 performs one or more steps of one or more methods described or illustrated herein or provides functionality described or illustrated herein. Some embodiments include one or more portions of the computing system 700.

The computing system 700 includes one or more processor(s) 701, memory 702, storage 703, an input/output (I/O) interface 704, a communication interface 705, and a bus 706. The computing system 700 may take any suitable physical form. For example, and not by way of limitation, the computing system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these.

The processor(s) 701 include hardware for executing instructions, such as those making up a computer program. The processor(s) 701 may retrieve the instructions from the memory 702, the storage 703, an internal register, or an internal cache. The processor(s) 701 then decode and execute the instructions. Then, the processor(s) 701 write one or more results to the memory 702, the storage 703, the internal register, or the internal cache. The processor(s) 701 may provide the processing capability to execute the operating system, programs, user and application interfaces, and any other functions of the computing system 700.

The processor(s) 701 may include a central processing unit (CPU), one or more general-purpose microprocessor(s), application-specific microprocessor(s), and/or special purpose microprocessor(s), or some combination of such processing components. The processor(s) 701 may include one or more graphics processors, video processors, audio processors and/or related chip sets.

In some embodiments, the memory 702 includes main memory for storing instructions for the processor(s) 701 to execute or data for the processor(s) 701 to operate on. By way of example, the computing system 700 may load instructions from the storage 703 or another source to the memory 702. During or after execution of the instructions, the processor(s) 701 may write one or more results (which may be intermediate or final results) to the memory 702. One or more memory buses (which may each include an address bus and a data bus) may couple the processor(s) 701 to the memory 702. One or more memory management units (MMUs) may reside between the processor(s) 701 and the memory 702 and facilitate accesses to the memory 702 requested by the processor(s) 701. The memory 702 may include one or more memories. The memory 702 may be random access memory (RAM).

The storage 703 stores data and/or instructions. As an example and not by way of limitation, the storage 703 may include a hard disk drive, a floppy disk drive, flash memory, an optical disc, a magneto-optical disc, magnetic tape, or a Universal Serial Bus (USB) drive or a combination of two or more of these. In some embodiments, the storage 703 is a removable medium. In some embodiments, the storage 703 is a fixed medium. In some embodiments, the storage 703 is internal to the computing system 700. In some embodiments, the storage 703 is external to the computing system 700. In some embodiments, the storage 703 is non-volatile, solid-state memory. In some embodiments, the storage 703 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. The storage 703 may include one or more memory devices. One or more program modules stored in the storage 703 may be configured to cause various operations and processes described herein to be executed.

The I/O interface 704 includes hardware, software, or both providing one or more interfaces for communication between the computing system 700 and one or more I/O devices. The computing system 700 may include one or more of these I/O devices, where appropriate. One or more of these I/O devices may enable communication between a person and the computing system 700. As an example and not by way of limitation, an I/O device may include a keyboard, keypad, microphone, monitor, mouse, speaker, still camera, stylus, tablet, touch screen, trackball, video camera, another suitable I/O device or a combination of two or more of these. An I/O device may include one or more sensors. In some embodiments, the I/O interface 704 includes one or more device or software drivers enabling the processor(s) 701 to drive one or more of these I/O devices. The I/O interface 704 may include one or more I/O interfaces.

The communication interface 705 includes hardware, software, or both providing one or more interfaces for communication (such as, for example, packet-based communication) between the computing system 700 and one or more other computing systems or one or more networks. As an example and not by way of limitation, the communication interface 705 may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network and any suitable communication interface 705 for it. As an example and not by way of limitation, the computing system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system 700 may communicate with a wireless PAN (WPAN) (such as, for example, a Bluetooth WPAN or an ultra wideband (UWB) network), a WI-FI network, a WI-MAX network, a cellular telephone network (such as, for example, a Global System for Mobile Communications (GSM) network), or other suitable wireless network or a combination of two or more of these. The computing system 700 may include any suitable communication interface 705 for any of these networks, where appropriate. The communication interface 705 may include one or more communication interfaces 705.

The bus 706 interconnects various components of the computing system 700 thereby enabling the transmission of data and execution of various processes. The bus 706 may include one or more types of bus structures including a memory bus or memory controller, a peripheral bus, and a local bus using any of a variety of bus architectures.

Various above-described operations performed by the server 101, the server 102, the server 103, and the server 104 may be executed and/or controlled by one or more applications running on the server 101, the server 102, the server 103, and the server 104, respectively. The above description serves to explain principles of the invention; but the invention should not be limited to the examples described above. For example, the order and/or timing of some of the various operations may vary from the examples given above without departing from the scope of the invention. Further by way of example, the type of network and/or computing systems may vary from the examples given above without departing from the scope of the invention. Other variations from the above-recited examples may also exist without departing from the scope of the invention.

The scope of the present invention includes a computer-readable storage medium storing instructions which, when executed by one or more processors, cause the one or more processors to perform one or more embodiments of the invention described herein. The scope of the present invention includes a computer-readable storage medium storing instructions which, when executed by one or more processors, cause the one or more processors to perform one or more embodiments of the invention described herein.

Examples of a computer-readable storage medium include a floppy disk, a hard disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

While the present invention has been described with reference to exemplary embodiments, it is to be understood that the invention is not limited to the disclosed exemplary embodiments.

What is claimed is:

1. A method comprising:
receiving, at a first server, a command that includes a first instruction for execution by the first server and a second instruction for execution by a second server, the first instruction comprising an instruction to update setting information associated with a client, the setting information including information representing a first value for a setting associated with the client, the second instruction comprising an instruction to update an appearance of a virtual object;
updating the setting information in accordance with the first instruction, wherein the updating the setting information includes storing information representing a second value for the setting, the second value different from the first value;
receiving, at the first server, an output request;
generating, in response to the output request, output data using current setting information associated with the client, the current setting information including the information representing the second value for the setting; and
outputting the output data to an output device.

2. The method of claim 1, wherein the first instruction comprises an instruction to reset the setting to a predetermined default value.

3. The method of claim 1, wherein the first instruction comprises an instruction to set the second value for the setting.

4. The method of claim 1, wherein the setting information includes the information representing the first value for the setting and further includes information representing a third value for a second setting associated with the client, and
wherein the current setting information includes the information representing the second value for the setting and further includes the information representing the third value for the second setting.

5. The method of claim 1, wherein the updating the setting information includes deleting the information representing the first value for the setting.

6. The method of claim 1, wherein the updating the setting information includes storing the first instruction in a log associated with the client.

7. The method of claim 1, further comprising:
receiving, after updating the setting information in accordance with the first instruction and before receiving the output request, a second command that includes a third instruction for execution by the first server and a fourth instruction for execution by the second server, the third instruction comprising an instruction to update setting information associated with a second client, the second client different from the client, the fourth instruction comprising an instruction to update the appearance of the virtual object; and
updating the setting information associated with the second client in accordance with the third instruction.

8. A method comprising:
receiving, at a first server, an identifier and a request to obtain setting information associated with the identifier and send the setting information to a second server;
using the identifier to obtain the setting information; and
sending, from the first server to the second server, the setting information and a command to apply the setting information to an image generated by the second server such that an appearance of a virtual object is updated according to the setting information.

9. The method of claim 8, further comprising:
associating, before receiving the identifier and the request, a unique string of characters with the setting information, wherein the identifier matches the unique string of characters.

10. The method of claim 9, wherein the associating the unique string of characters with the setting information comprises:
sending, from the first server to a third server, the setting information and a request to generate the unique string of characters and store the unique string of characters and the setting information in a data store such that the unique string of characters is associated with the setting information in the data store.

11. The method of claim 8, wherein the identifier comprises a string of characters generated based on one or more user inputs received at a client.

12. The method of claim 8, wherein the using the identifier to obtain the setting information comprises:
sending, from the first server to a third server, the identifier and a request for the setting information associated with the identifier; and
receiving, at the first server from the third server, the setting information.

13. The method of claim 8, wherein the using the identifier to obtain the setting information comprises:
identifying a string of characters that matches the identifier; and
retrieving the setting information associated with the string of characters.

14. A method comprising:
receiving, at a computing system from a client, user input information, the user input information based on one or more user inputs received at the client;
generating a command based on the user input information, the command including a first instruction for execution by a first server and a second instruction for execution by a second server, the first instruction comprising an instruction to update setting information associated with the client, the second instruction comprising an instruction to update an appearance of a virtual object; and
sending, from the computing system to the first server and to the second server, the command.

15. The method of claim 14, further comprising:
receiving, at the computing system from a browser on the client, a request to access a resource; and
sending, from the computing system to the client, the resource, the resource including one or more elements enabling user interaction when the resource is displayed in the browser,
wherein the receiving the user input information comprises receiving, at the computing system from the browser on the client, the user input information after sending the resource.

16. The method of claim 14, wherein the user input information comprises information sent to the computing system in response to a selection of an interface element presented in a graphical user interface on a display of the client.

17. The method of claim 14, wherein the first instruction comprises an instruction to change multiple setting values associated with the client, and
wherein the second instruction comprises an instruction to modify multiple features of the virtual object.

18. The method of claim 14, wherein the first instruction comprises an instruction to set a specified value for a specified setting associated with the client, and
wherein the second instruction comprises an instruction to apply a specified change to a specified feature of the virtual object.

19. The method of claim 14, wherein the instruction to update the setting information corresponds to the instruction to update the appearance of the virtual object.

20. The method of claim 14, further comprising:
receiving, at the computing system from a second client, second user input information, the second client different from the client, the second user input information based on one or more user inputs received at the second client;
generating a second command based on the second user input information, the second command including a third instruction for execution by the first server and a fourth instruction for execution by the second server, the third instruction comprising an instruction to update setting information associated with the second client, the fourth instruction comprising an instruction to update the appearance of the virtual object; and
sending, from the computing system to the first server and to the second server, the second command.
